(19) United States
(12) Patent Application Publication
(10) Pub. No.: US 2003/0055828 A1
(43) Pub. Date: Mar. 20, 2003

(54) Methods for synchronizing on-line and off-line transcript projects

(76) Inventors: Kevin S. Koch, Grand Junction, CO (US); Peter Berglund, Greenwood Village, CO (US); Davin J. Fifield, Denver, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/112,687

(22) Filed: Mar. 29, 2002

Related U.S. Application Data
(60) Provisional application No. 60/279,948, filed on Mar. 29, 2001.

(51) Int. Cl. G06F 7/00; G06F 17/30

(52) U.S. Cl. 707/10

(57) ABSTRACT

A method for synchronizing off-line and on-line transcript projects which may contain electronic transcripts and user-created annotations or notations which are electronically associated with the respective electronic transcripts. The method includes providing a database containing one or more electronic transcript files and having one or more sets of annotations associated with the one or more electronic transcript files, the database being accessible over a network. An off-line database is created in a user device, the off-line database containing a copy of at least one of the electronic transcript files and a copy of at least one set of the annotations. In the user device, a user may manipulate the copy of at least one set of the annotations, while the user device is not connected to the network, to form an off-line version of the annotations. When the user device is connected to the network, it is determined whether the off-line version of the annotations contains a change from the one or more sets of annotations in the database, and if so, writing the change to the database. Further, it may be determined whether the one or more sets of annotations in the database contain a change from the off-line version of the annotations, and if so, writing the change to the off-line database.

### CROSS-REFERENCE TO RELATED APPLICATION

This application claims priority under 35 U.S.C. 119(e) to U.S. provisional patent application Serial No. 60/279,948 entitled “METHODS FOR SYNCHRONIZING ON-LINE AND OFF-LINE TRANSCRIPT PROJECTS” filed Mar. 29, 2001, the disclosure of which is hereby incorporated by reference in its entirety.

### FIELD OF THE INVENTION

The present invention relates, in general, to methods for synchronizing off-line and on-line transcript projects which may contain electronic transcripts and user-created annotations or notations which are electronically associated with the respective electronic transcripts.

### BACKGROUND OF THE INVENTION

Legal transcripts are used to memorialize the events which occur in a deposition or courtroom proceeding or the like. With the advent of electronic transcripts, transcript management software programs—such as realLegal.com's “e-TRANSCRIPT BINDER” (™) program—permit a user to access and review electronic transcripts, perform word searches of the transcripts, associate annotations and issue codes with particular words or phrases or sections of the transcripts, etc.

The BINDER (™) transcript management software program stores the electronic transcripts in a master database accessible by various users over a network, in an “on-line” mode where the user is connected to the network, such as through a company LAN or the Internet, to access the master database. An individual user can organize a set of transcripts into a “project” which is managed in the master database, and the project also contains various annotations and issue codes created by the user (or created by other users) associated with particular transcripts.

As recognized by the present inventors, what is needed in an embodiment is a method and system for permitting a user to perform various functions (i.e., adding annotations or issue codes to a project) using the transcripts when the user is “off-line,” for instance, when the user is traveling with a laptop computer having the transcript management software program loaded locally on the laptop computer. When such changes to the project are made during “off-line” operations, as recognized by the present inventors, what is needed is a method for synchronizing the master project to reflect the changes made by the user during off-line operations.

Also, as recognized by the present inventors, when a second user has altered the master project while the first user is altering the project in an “off-line” mode, what is needed in another embodiment is a method for synchronizing the first user's off-line project to the master project so that the second user's changes to the master project are properly reflected/transferred into the first user's off-line project when the first user re-connects.

Furthermore, an on-line master word index is maintained which permits a user to easily jump to certain words within one or more transcripts of a project through the graphical user interface of the transcript management software. The master word index typically contains a word index which is based on the words contained in all of the transcripts in the master project. Accordingly, as recognized by the present inventors, when a user desires to access transcripts off-line, what is needed in another embodiment is a method for efficiently providing a word index for the off-line word search operations.

Furthermore, due to some Microsoft Windows system constraints, it is often a time-consuming and lengthy process to determine if a project and the associated transcripts thereof are available on-line or off-line. Accordingly, as recognized by the present inventors, what is needed in another embodiment is a method for efficiently and automatically detecting the on-line/off-line status of a project so as to reduce the amount of time which the user experiences during such determination.

It is against this background that various embodiments of the present invention were developed.

### SUMMARY OF THE INVENTION

According to one embodiment of the invention, disclosed herein is a method for synchronizing off-ine and on-ine transcript projects which may contain electronic transcripts and user-created annotations or notations which are electronically associated with the respective electronic transcripts. The method includes providing a database containing one or more electronic transcript files and having one or more sets of annotations associated with the one or more electronic transcript files, the database being accessible over a network. An off-line database is created in a user device, the off-line database containing a copy of at least one of the electronic transcript files and a copy of at least one set of the annotations. In the user device, a user may manipulate the copy of at least one set of the annotations, while the user device is not connected to the network, to form an off-line version of the annotations. When the user device is connected to the network, it is determined whether the off-line version of the annotations contains a change from the one or more sets of annotations in the database, and if so, writing the change to the database. Further, it may be determined whether the one or more sets of annotations in the database contain a change from the off-line version of the annotations, and if so, writing the change to the off-line database.

Other embodiments of the invention are disclosed herein. The foregoing and other features, utilities and advantages of various embodiments of the invention will be apparent from the following more particular description of the various embodiments of the invention as illustrated in the accompanying drawings and claims.

### BRIEF DESCRIPTION OF THE DRAWINGS

FIG. 1 illustrates a block diagram of a master project available to multiple users over the network, and off-line projects maintained locally by individual users, in accordance with one embodiment of the present invention.

FIG. 2 illustrates one example of the logical operations for synchronization between an off-line project and a master project, in accordance with one embodiment of the present invention.

FIG. 3 illustrates a sample display screen of a transcript management software program during on-line operations, in accordance with one embodiment of the present invention.

FIG. 4 illustrates a sample display screen showing a pop-up menu providing a user control to enable/disable off-line availability of a selected transcripts (open during on-line operations), in accordance with one embodiment of the present invention.

FIG. 5 illustrates a sample display screen showing various transcripts and whether there availability off-line has been enabled or disabled, in accordance with one embodiment of the present invention.

FIG. 6 illustrates a sample display screen showing a project synchronization control, in accordance with one embodiment of the present invention.

FIG. 7 illustrates a sample display screen showing various user controllable options for synchronization, in accordance with one embodiment of the present invention.

FIG. 8 illustrates a sample display screen showing a user selectable control for opening a project in an off-line mode, in accordance with one embodiment of the present invention.

FIG. 9 illustrates a sample display screen showing a transcript management software program during off-line operations, in accordance with one embodiment of the present invention.

FIG. 10 illustrates a sample display screen showing, during off-line operations, issue codes/annotations associated with transcripts available off-line, in accordance with one embodiment of the present invention.

FIG. 11 illustrates a sample display screen showing a user selectable control for synchronizing off-line projects to master projects, in accordance with one embodiment of the present invention.

FIG. 12 illustrates a sample display screen showing, during on-line operations, various annotations/issue codes for various transcripts, in accordance with one embodiment of the present invention.

FIG. 13 illustrates one example of logical operations for initialization a synchronization process, in accordance with one embodiment of the present invention.

FIG. 14 illustrates an example of an off-line transcripts table, in accordance with one embodiment of the present invention.

FIGS. 15A-B illustrate one example of logical operations for a synchronization process, in accordance with one embodiment of the present invention.

FIGS. 16A-B illustrate one example of an example of a database schema of the master project database, in accordance with one embodiment of the present invention.

FIG. 17 illustrates an example of the use of conflict tables, in accordance with one embodiment of the present invention.

FIGS. 18A-B illustrate one example of logical operations for resolving a conflict, in accordance with one embodiment of the present invention.

FIG. 19 illustrates one example of logical operations for determining an on-line/off-line status of a project, in accordance with one embodiment of the present invention.

FIG. 20 illustrates a sample display screen showing the playing of a video file associated with text of a transcript, in accordance with one embodiment of the present invention.

FIG. 21 illustrates a sample display screen showing the selection of a video plug-in in order to play video associated with an electronic transcript, in accordance with one embodiment of the present invention.

### DETAILED DESCRIPTION

According to one broad aspect of one embodiment of the invention, disclosed herein is a method for permitting a user to select transcripts of a project to be available off-line on the user's local computer, utilize the transcripts off-line, and then synchronize the on-line “master” project to reflect the changes made during off-line operations. Further, according to another embodiment, disclosed herein is a method for synchronizing/updating the off-line project maintained locally by a user with changes that have been made to the on-line master project (i.e., where a second user has revised the master project). Furthermore, according to another embodiment, a method is disclosed herein for efficiently providing a word index for off-line operations. A method for efficiently detecting the on-line/off-line status of a project is also disclosed herein according to another embodiment. A discussion of video/transcript data in a single XML file is also provided herein.

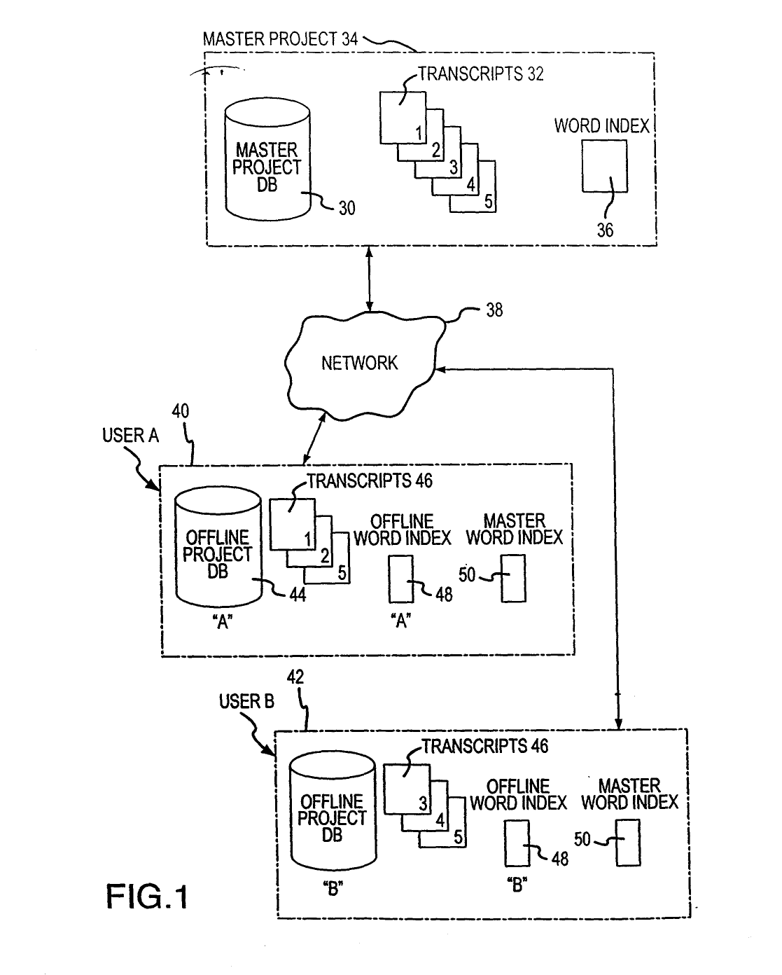

FIG. 1 illustrates a block diagram in accordance with one embodiment of the present invention wherein a master project database 30 is maintained and has a plurality of transcripts 32 associated therewith. A master project 34 preferably includes a master project database 30, one or more transcripts 32, and a master word index 36; and in one example, the master project further includes annotations, issue codes, table of contents entries, search groups, user specific settings, reports, folder structures, users, and/or video files, if available, for example as shown variously herein. The master project 34 is preferably made available to multiple users over a network 38, such as the Internet, as shown in FIG. 1.

The master project database 30 tracks and maintains the various transcripts 32 and the annotations/issue codes and other elements of the master project 34. The master word index 36 provides an electronically searchable word index to one or more of the transcripts of the master project, and preferably provides a word index so that all of the transcripts associated with the master project 34 can be easily searched electronically. During operations in on-line mode, as users change annotations or other elements of the master project 34, these changes are written to the master project database 30 and are visible globally to any and all users which have access to the master project database 30 over the network.

In FIG. 1 both users A and B each have “off-line” projects 40, 42, an off-line project database 44 (which is preferably a replica of the master project database) on a user device—such as a laptop computer—and copies 46 of the one or more transcripts which the users have selected for “off-line” availability. The off-line projects 40, 42 preferably include an off-line project database 44, one or more transcripts 46, and a word index 48 and a copy 50 of the master word index 36; and in one example, the off-line project further includes annotations, issue codes, table of contents entries, search groups, user specific settings, reports, folder structures, users, and/or video files, if available. In one example, the off-line database contains a copy of at least one electronic transcript and a copy of the annotations or other data elements associated with the at least one electronic transcript. In one example, the copy 50 of the master word index 36 is maintained locally and only used when the user is connected to the master project 34.

The off-line project database 44 tracks and maintains the various transcripts 46 and the annotations/issue codes and other elements of the master project. The off-line word index 48 provides an electronically searchable word index to one or more of the transcripts 46 of the off-line project, and preferably provides a word index so that all of the transcripts associated with the off-line project can be easily searched electronically.

In accordance with one embodiment of the present invention, users can access the master project 34 over the network 38 in an “on-line” mode and select particular transcripts 32 of a master project to be made available for use in a “off-line” mode when the user's local computer (for example, a laptop) is being used or when the network 38 connection to the master project is not available. In this manner, a user can select particular transcripts 32 from the master project 34 and work with those projects on the user's device (i.e., a laptop computer) when the user is on a plane, in a taxicab, in a hotel room, or in other situations where a network connection is not available. When a network connection becomes available and the user accesses the master project over the network, the changes which were made by the user to the off-line project are synchronized or transferred to the master project.

By providing that the changes made to an off-line project 40, 42 are properly reflected in the master project 34 on-line, those changes then become available, viewable, and accessible to all users of the project over the network. In this manner, embodiments of the present invention permit various users to perform different operations to the project—irrespective of whether the users are using the master project on-line, or using the project in an off-line mode. For instance, if an attorney in the San Francisco office of a law firm uses the project in a “off-line” mode while the attorney is traveling by airplane to Australia, when the attorney arrives in Australia, the attorney can connect to the network (for example, a LAN or the Internet) and synchronize the master project 34 with the changes made to the off-line project 40, 42 so that users at the home office in San Francisco (and anyone else with access to the master project over the network) can benefit from the work done by the attorney during the off-line mode.

Referring to FIG. 1, if user A during on-line operations selects transcripts 1, 2 and 5 for off-line availability, then these transcripts are stored in the off-line project 40 on user A's local computer. Accordingly, as the user manipulates the off-line project 40, for instance, by reviewing and creating annotations for transcripts 1, 2 or 5, and possibly performing other functions such as creating annotations and issue codes or other operations, then in accordance with one embodiment of the present invention, an off-line version of the project is created to capture the changes and these changes are later transferred or uploaded to the master project 34 when the user again accesses the master project through the network 38.

Likewise, user B shown in FIG. 1 is also provided with the ability to select transcripts for off-line usage, and in the example shown, transcripts 3, 4, and 5 have been made available for off-line usage in an off-line project 42 maintained within the user B's local computer. Changes to the off-line project associated with transcripts 3, 4, or 5 made by user B are also reflected in the master project 34 when user B later accesses the master project over the network 38.

Furthermore, changes in the master project 34 are reflected down into the off-line project 40, 42 of the users as appropriate. For instance, in the example shown in FIG. 1, assume that user A has entered off-line operations with transcripts 1, 2, and 5, while user B is operating in on-line operations and creates annotations and issue codes associated with transcript 5 in the master project 34. Accordingly, when user A later accesses the master project 34 in an on-line mode, then the annotations and issue codes and other changes initiated by user A will be transferred up to the master project 34, and likewise, the changes to the master project made by User B with respect to transcript 5 will be reflected down to the off-line project database 44 of offline project 40 for user A, in accordance with one embodiment of the present invention. In this manner, embodiments of the present invention provide a consistent and up-to-date version in both the master project and any off-line projects that exist during the life of the projects.

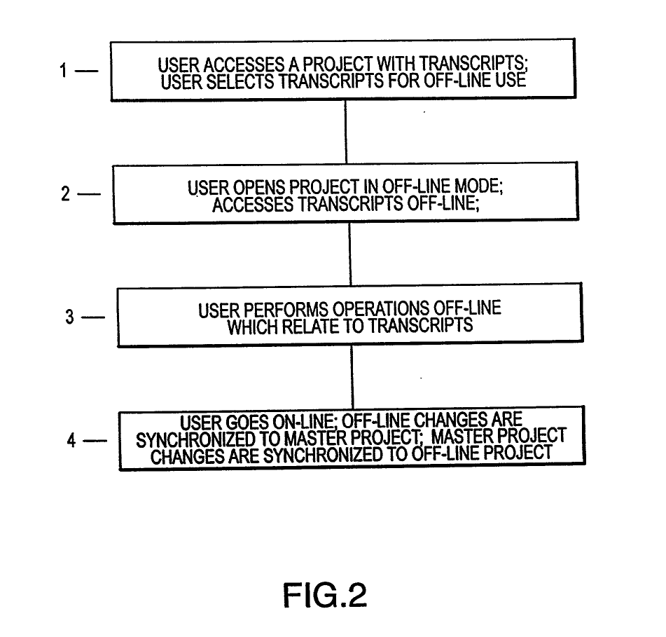

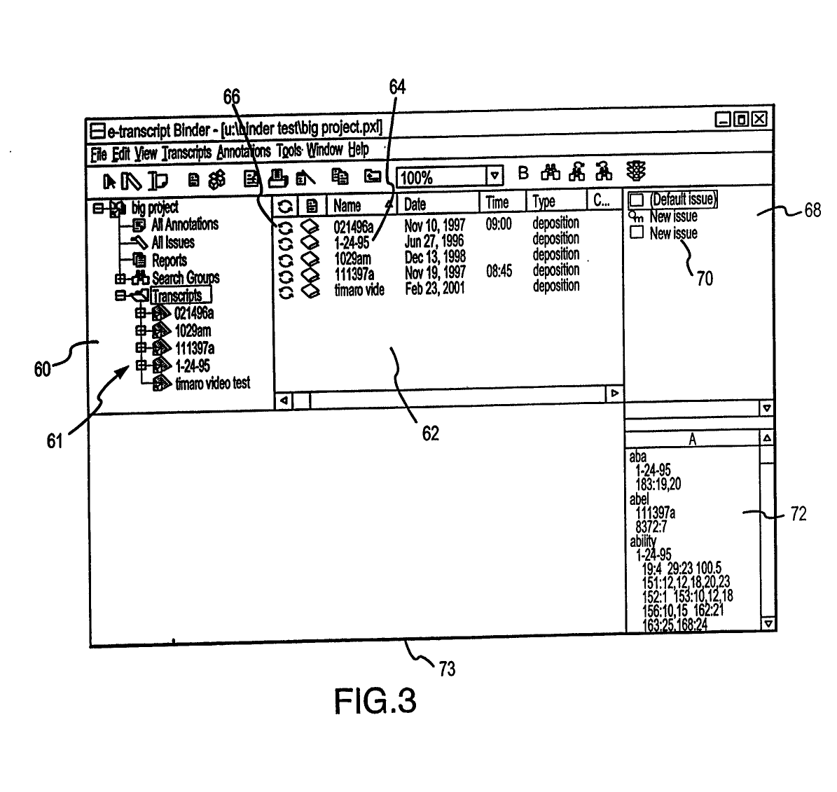

Referring now to FIG. 2, the logical operations for synchronizing on-line and off-line projects are illustrated in accordance with one embodiment of the present invention. These operations will be described with reference to the sample display screens shown in FIGS. 3-12.

At operation 1 of FIG. 2, a user accesses a master project “on-line,” where the master project has one or more transcripts associated with it, and the user selects one or more of the transcripts of the master project for off-line use. Operation 1 of FIG. 2 will now be further described with reference to the example display screens shown in FIGS. 3-7. Referring now to FIG. 3, a sample display screen of transcript management software, such as realLegal.com's “Binder” (™) program, is shown during “on-line” operations. One embodiment of a transcript management software program is described in co-pending, commonly assigned U.S. application Ser. No. 09/920,443 entitled “TRANSCRIPT MANAGEMENT SOFTWARE AND METHODS THEREFOR,” by Davin Fifield and Kevin Koch, filed on Jul. 31, 2001, the disclosure of which is herein incorporated by reference in its entirety.

The display is provided with a tree control pane 60, which shows projects and the annotations, issues, reports, search groups and transcripts 61 associated with the project. In this example, the master project is shown as “big project” and has five transcripts associated therewith. A central display pane 62 shows the transcript names and details 64 of the project, and an off-line status icon 66 is provided for each transcript to indicate whether the particular transcript of the master project has been selected for off-line use or is available off-line (i.e., if it was previously selected and downloaded for off-line use). An issue pane 68 with issue codes 70 is also provided, along with a word index pane 72 with the word index therein. A transcript pane 73 displays the content, or portions thereof, of a transcript, in one example.

The off-line status icon 66 indicates whether the transcript is presently available off-line, or has been selected by the user to be available for off-line operations. For instance, a transcript with the off-line status icon 66 enabled means that the user has selected the transcript for availability off-line, or that the transcript is present in the user's off-line project database. If, however, a transcript does not have the off-line status icon 66 enabled, then the transcript will not be available when the user enters off-line operations. In one example, each transcript within a project is, by default operation of the transcript management software, selected for availability off-line, and accordingly, the transcripts listed in FIG. 3 are illustrated each having the off-line status icon enabled. Further, in one example, when a particular transcript is selected to be available off-line (or is already available off-line), then the transcript icon for the transcript shown in the tree control pane has an arrow shown within the icon, as can be seen in FIGS. 3-6.

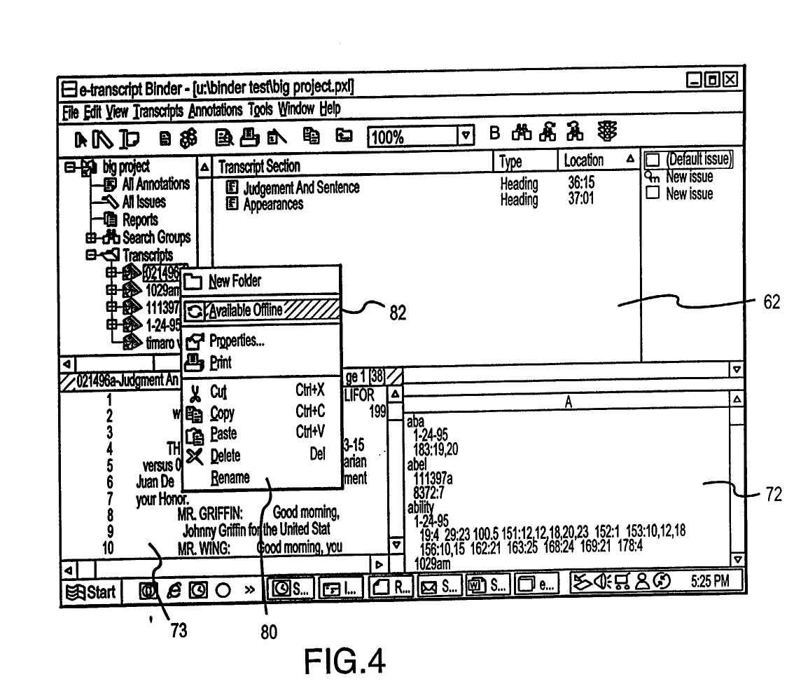

FIG. 4 illustrates a pop up menu 80 which provides a control button 82 to permit a user to make a particular selected transcript available off-line, or to deselect a particular transcript from being available off-line, in one example of the present invention. Accordingly, a user can dynamically choose which transcript of a master project should be available as part of an off-line project. As shown in FIG. 4, the transcript entitled “021496a” is being selected by the user to be available off-line.

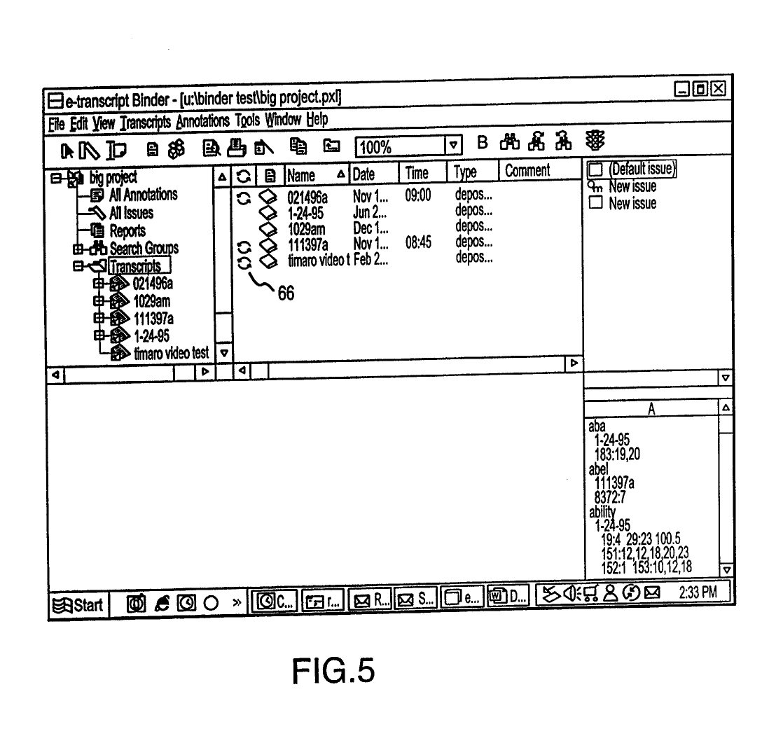

FIG. 5 illustrates the sample display screen of FIG. 4 after the user has selected particular transcripts of the master project “big project” to be available off-line. As shown in FIG. 5, three transcripts in the master project have been selected to be available off-line (see status icon 66). In one example of the present invention, after the user has selected projects to be available off-line and the user closes the transcript management software program (while in on-line operations), the appropriate transcripts are copied down to the user's local computer and stored locally in the local project maintained therein.

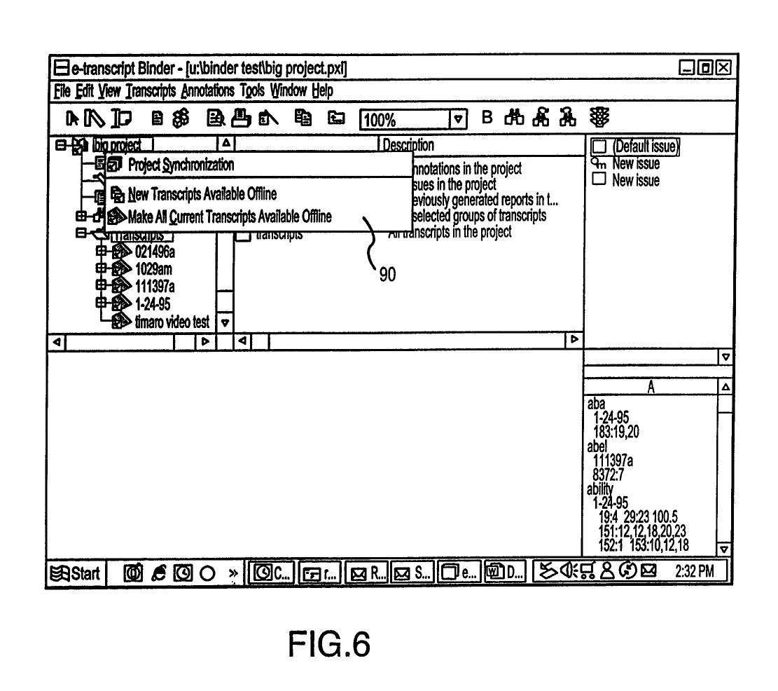

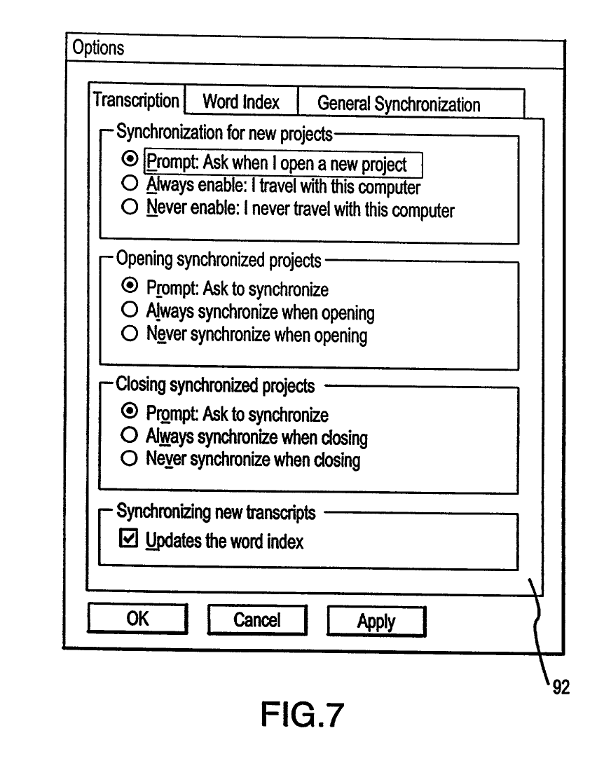

Referring to FIGS. 6-7, controls 90, 92 are provided so that the user can control whether all new transcripts added to a master project should, by default, be made available off-line, whether projects should be synchronized upon opening or closing thereof, and whether to enable or disable the updates of word indexes during synchronization. These controls 90, 92 are provided so that a user can customize these operations to the user's preference.

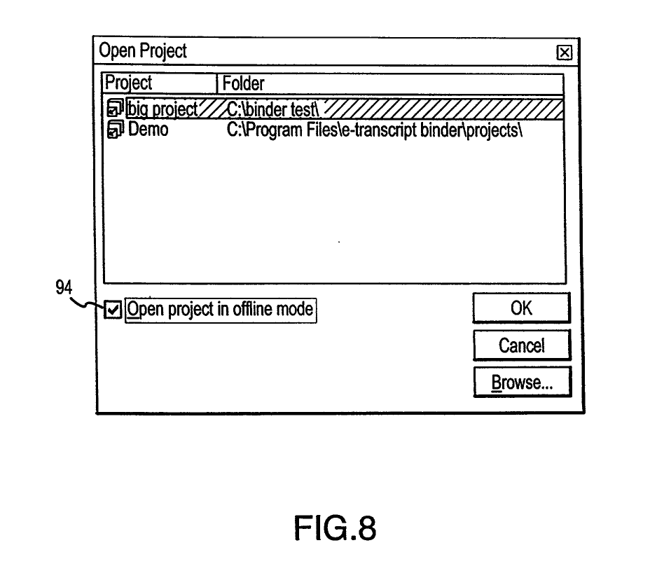

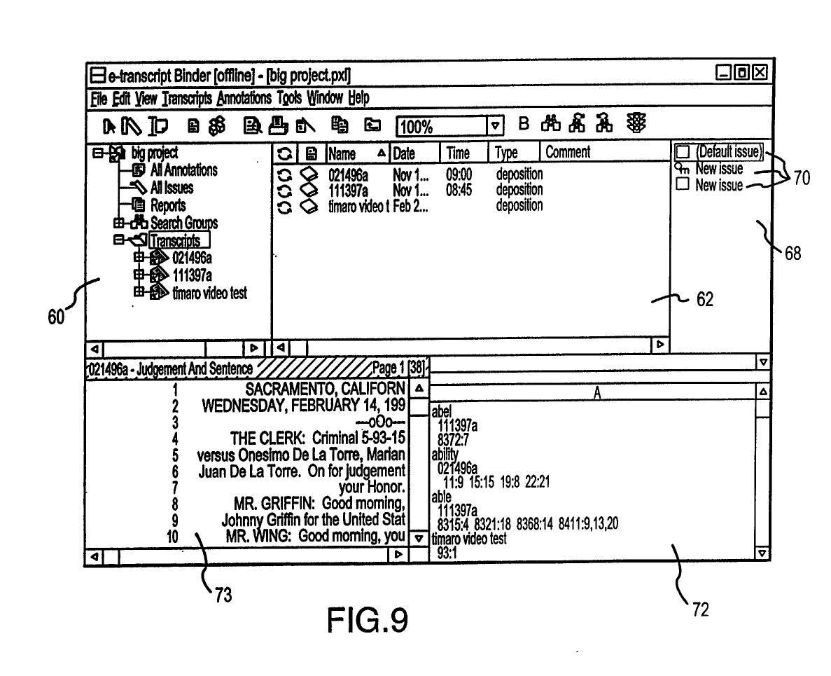

Referring again to FIG. 2, at operation 2, the user opens a project in off-line mode to begin off-line operations, and the user accesses as desired the transcripts available in the off-line mode. Again, such access in off-line mode may occur when the user is using the transcript management software and no network connection is readily available—such as when the user is in an airport, on an airplane, at home, in a client's office, or any other location or situation when the network is not available, or excessively slow. Operation 2 will be described with reference to sample display screens shown in FIGS. 8-9, in one example of the invention. As shown in FIG. 8, a sample display screen provides the user with a control 94 to open a particular project in an off-line mode.

Assuming the user has opened the project entitled “big project” for off-line mode, FIG. 9 illustrates a sample display screen of the transcript management software during off-line operations. As shown in FIG. 9, both the tree control pane 60 and the central display pane 62 indicate that the transcripts which the user previously selected to be available off-line are in fact available off-line. The word index pane 72 shown in FIG. 9, preferably includes an index to words which are present in the transcripts available off-line; and the issue pane 68, showing the issue codes 70, preferably displays issue codes associated with the off-line transcripts, in one example of the invention. The transcripts are accordingly now ready for the user to access in off-line mode.

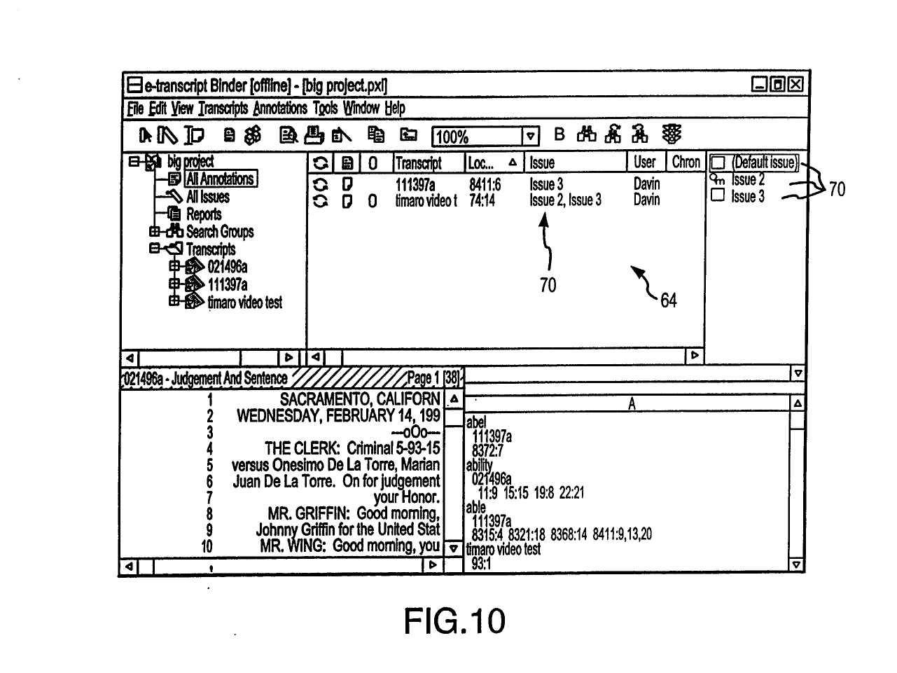

Referring to FIG. 2, at operation 3, using the off-line project, the user performs operations which relate to the transcripts available off-line. For instance, in one example, the user can add annotations based on the off-line transcripts, create issue codes based on the off-line transcripts, or perform other operations associated with the off-line transcripts. Furthermore, a user could add new transcripts to either the master project or the off-line project, if desired. Referring to FIG. 10, the details pane 64 shows the issue codes 70 for the off-line transcripts. For example, in transcript “111397a,” the issue code “Issue 3” is located at 8411:6 (page:line) and was created by user “Davin” during the off-line session. For the “timaro video” transcript, the issue codes “Issue 2” and “Issue 3” were also established by user “Davin” during the off-line session. It is understood that the annotations and issue codes shown herein are by way of example only, and that the present invention would permit the user to manipulate the off-line project in any way deemed necessary, and to have those changes reflected back to the master project during synchronization.

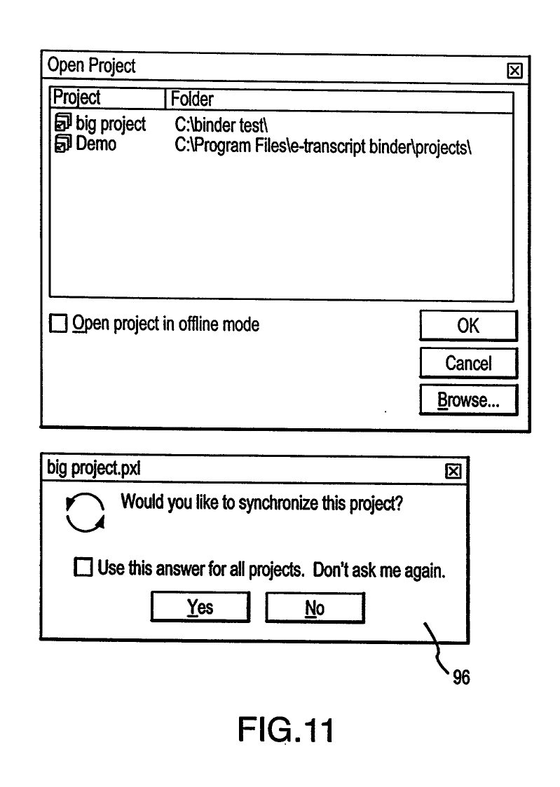

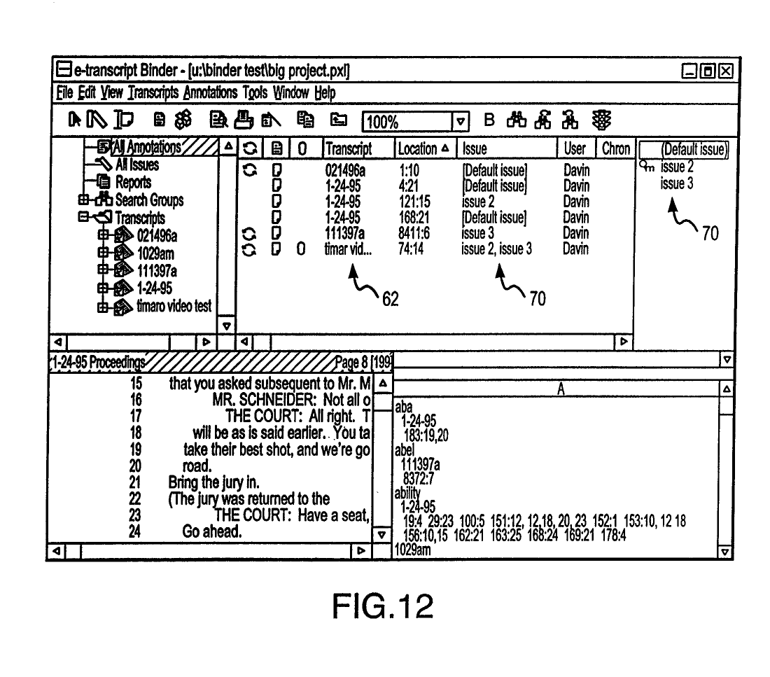

Once the user has completed the operations to the off-line project, the user can then run the transcript management software in an on-line mode when a network connection is available, and the changes from the off-line project will be transferred/synchronized to the master project on-line. Referring to FIG. 2, at operation 4, the user goes on-line with the project, and off-line changes are synchronized to the master project on-line. Furthermore, any changes to the master project are synchronized to the off-line project so the off-line project is current. Referring to FIG. 11, a sample display screen is shown wherein upon selecting a project to open during on-line operations, the user is asked through prompt 96 whether to synchronize this project, meaning that the changes made during the off-line session should be reflected into the master project, and vice versa, as described above. FIG. 12 illustrates a sample display screen during “on-line” operations after synchronization, where all of the annotations 70 for the various transcripts of “big project” are shown in the central display pane 62. As can be seen in FIG. 12, three transcripts were made available off-line, including the “021496a” transcript, the “111397a” transcript, the “timaro video” transcript. Further it can be seen that the annotations/issue codes 70 which were created by user “Davin” during the off-line sessions (see FIG. 10) are now available in the master project in FIG. 12—and therefore are globally viewable and useable by all users of the project using the transcript management software.

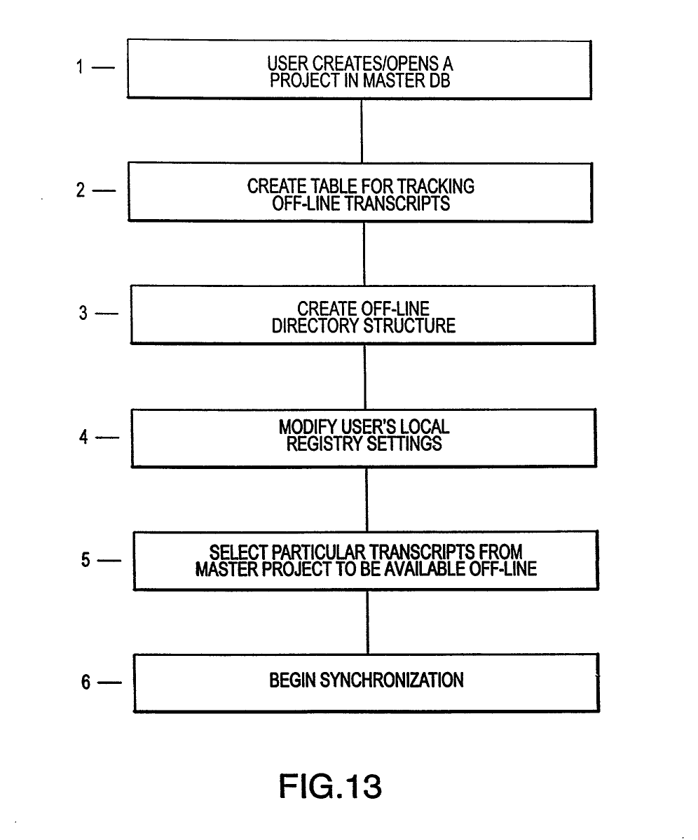

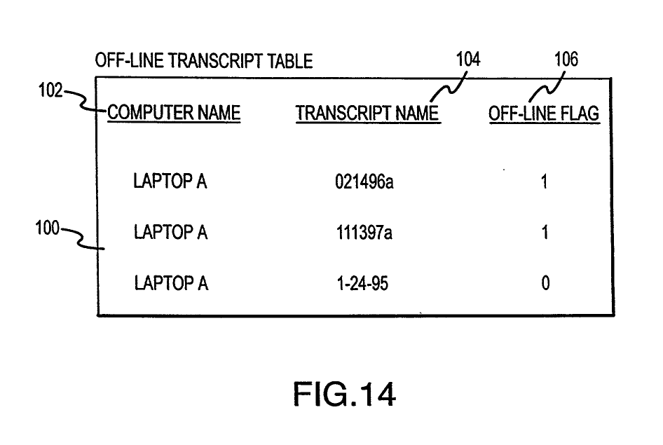

Referring now to FIG. 13, an example of logical operations are illustrated for initializing a synchronization process, in accordance with one embodiment of the present invention. At operation 1, the user creates or opens a project in the master database during on-line operations; and in one example, the user specifies that a particular project is to be available off-line. At operation 2, a table or other data structure is created in the master database for tracking the off-line transcripts. In one example, the table 100 is shown in FIG. 14, and has a “computer name” column 102, a “transcript” column 104, and a “off-line flag” column 106. The computer name column 102 preferably is a unique identifier of a computer from which a user is using the transcript management software. In one example, the computers listed under the computer name column 102 are preferably referenced by their “NET BIOS” name. The transcript column 104 preferably includes the name or identifier of the transcript for this row in the table, and the off-line flag 106 is preferably set when the transcript is available or has been selected to be available off-line, and cleared if the transcript is not available (and has not been selected to be available) off-line.

At operation 3 of FIG. 13, an off-line directory file structure is created on the users local computer, wherein the directory structure provides a structure for which to store the off-line files. In one example, the off-line files which will later be added to the directory structure will include the off-line transcripts selected by the user, a off-line project database, and an off-line word index.

At operation 4, the user's Windows registry settings of the local computer are written to indicate that off-line projects exist and their locations. This operation is used when the local operating system is Microsoft Windows™, and is useful for subsequent operations.

In operation 5, the user selects particular transcripts from the master project to be available off-line. In one example, when the user selects a particular transcript to be available off-line, not only will the transcript be available off-line, but the word index and any annotations/issue codes associated with the transcript will also be available off-line.

At operation 6, the synchronization process is ready to begin. In one example, operation 6 provides a control (see FIGS. 6-7, for example) to the user so that synchronization can be automatic under certain conditions, such as when the user closes the transcript management software when exiting on-line operations, or when the user is opening the transcript management software and beginning on-line operations.

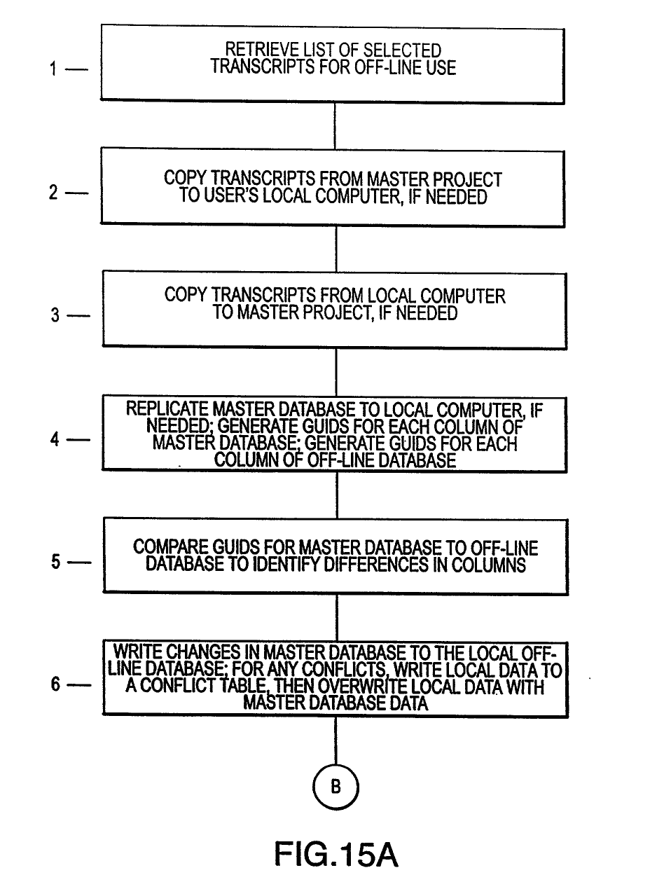

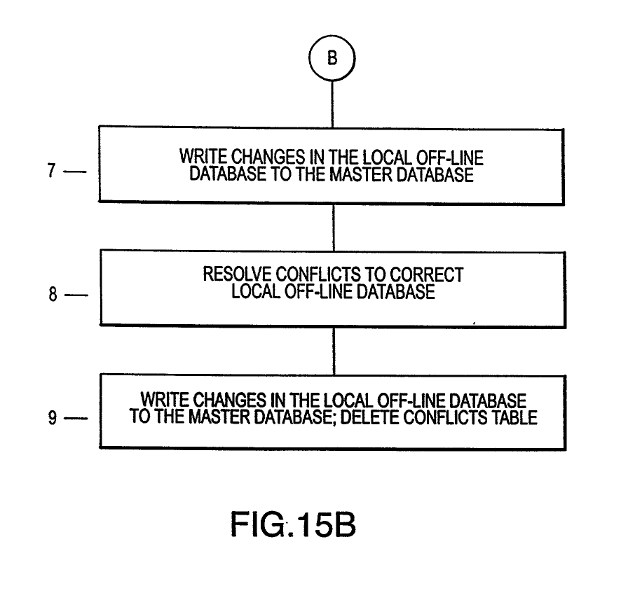

FIGS. 15A-B illustrate an example of logical operations for a synchronization process, in accordance with one embodiment of the present invention. Preferably and in one example, the synchronization process is a “two-way” process, wherein changes made in the off-line project are reflected into the master project, and changes in the master project are reflected into the off-line project. During synchronization, the elements of the project, i.e., the annotations, issue codes, transcripts, etc., will be synchronized between the on-line/off-line projects because, as will be described, the master database and the off-line database will be made to be substantially identical with respect to their data content associated with the off-line transcripts.

In one example, the synchronization process generally includes three steps: (1) the transcripts are copied; (2) conflicts between databases are detected and while conflicts exists, non-conflicting data is copied to the user's database, then the conflicts are resolved; and (3) the word index is built. During the synchronization process, conflicts are resolved between the master project and the off-line project, and any annotations, issues, transcripts, etc. which may need to be re-referenced are done so that the integrity of the references is maintained.

Conflicts between the master database and the off-line database can occur in various situations, for example, when two users update the same record in two different databases in a replica set. Conflicts can also occur when a change to data in one database in a replica set cannot be applied to another database in the replica set because the change would violate a constraint such as referential integrity or uniqueness. Examples of conflicts include simultaneous update conflicts, when two users update data in the same record or file of the database; an update-delete conflict, wherein a record which has been deleted and was also updated by another user; a unique key conflict wherein two records contain the same key value, even though only unique values are permitted; a table level validation conflict, where a record contains a value field that does not meet a table level validation rule. Referential integrity conflicts may occur when 1) a conflict exists on delete because a primary record has been deleted in another replica, and therefore the foreign record has been rejected; 2) a conflict exists on update, where the primary key has been updated in another replica, and therefore the foreign record has been rejected; or 3) a conflict exists for a foreign key where a foreign key violation resulted from an invalid primary record that was involved in another replication conflict type. A conflict may also exist in a locking situation, where the record change could not be applied during synchronization because another user locked the table involved. In each of these situations, preferably, the conflict is written to the conflict table and resolved as described herein.

Referring to FIGS. 15A-B, operation 1 retrieves a list of off-line transcripts from the master database, this list indicating the transcripts which the user has indicated should be available off-line. At operation 2, any transcripts marked for off-line availability are copied from the master project to the user's local computer. Operation 2 preferably determines if a transcript selected for off-line availability already exists off-line, and if so, then the transcript itself need not be re-copied to the local computer. At operation 3, any new transcripts added to the off-line project which are not present in the master project are copied to the master database (assuming these transcripts don't already exist in the master project).

At operations 4-9, the master project database and the off-line project database are synchronized. At operation 4, if the local computer does not yet have a off-line project database (i.e., this is the first time the local computer is going through the synchronization process), then a replication operation is performed which replicates the master database to the local computer. In one example, the replication operation is a jet replication object (JRO) replication operation of Microsoft Access, which makes a complete copy of the master database to the local computer. The JRO is a Microsoft Dynamic Link Library (DLL) COM object.

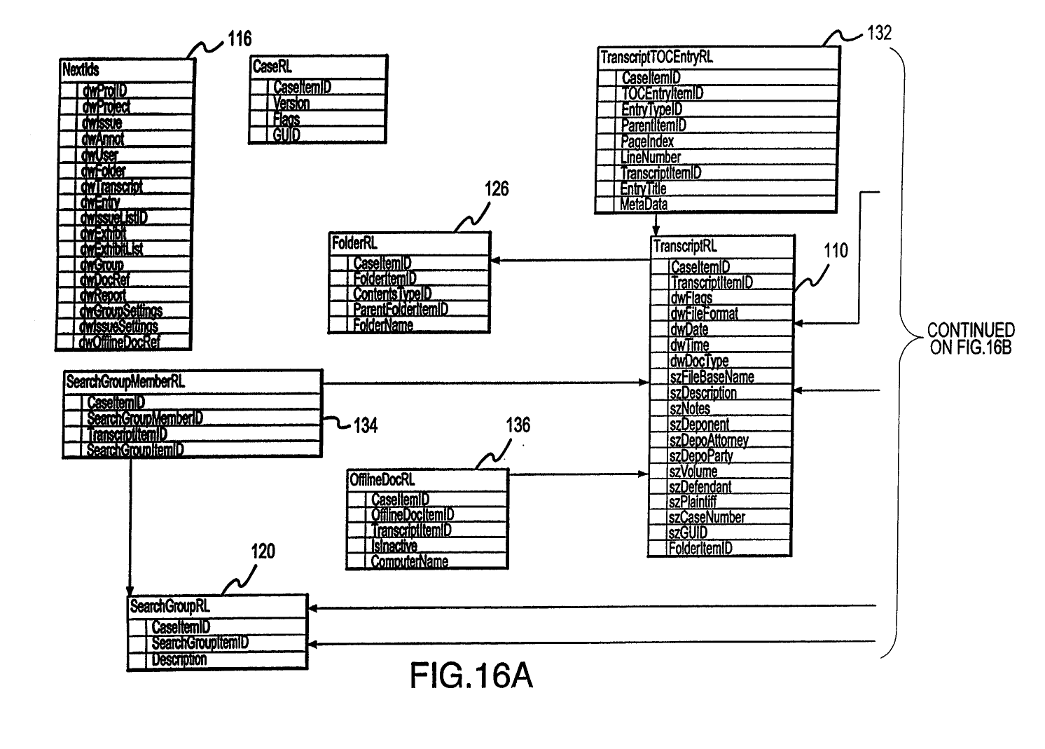

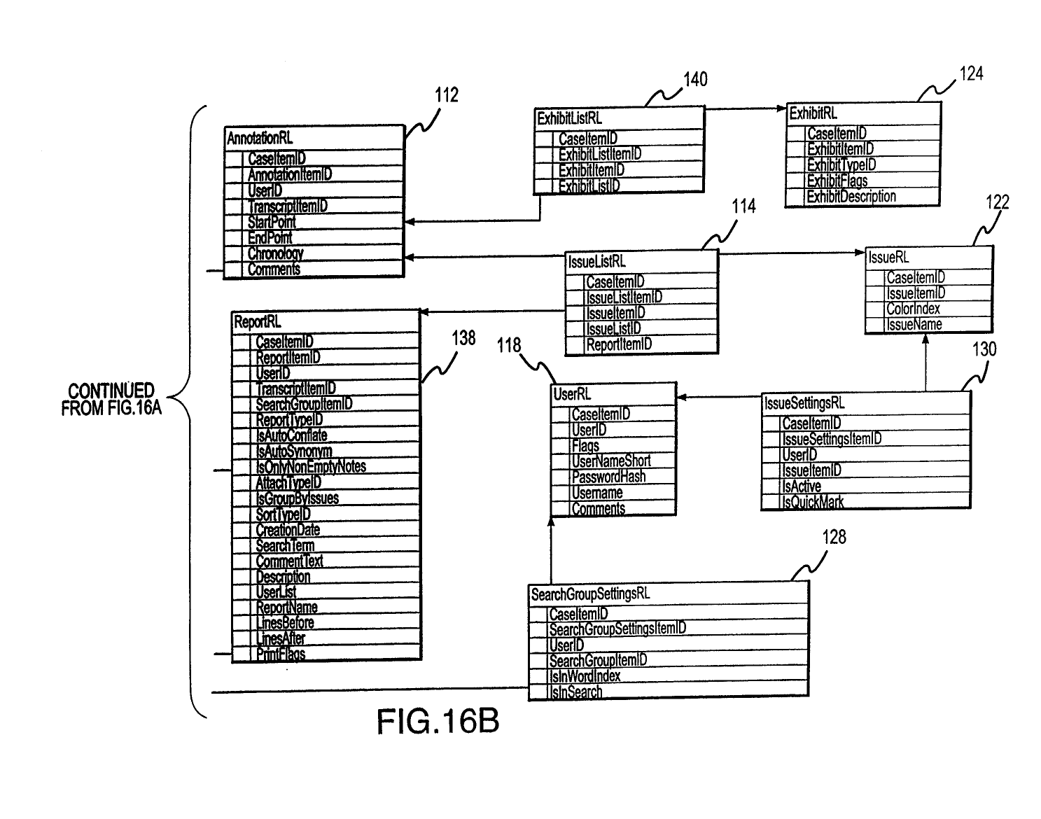

One example of a database structure for handling projects is illustrated in FIGS. 16A-B. FIGS. 16A-B show a schema or entity relationship diagram for one example of a database implementation for transcript management software, and the schema could be used for making the master database. As shown in FIGS. 16A-B, various tables are maintained for a project, including a transcript table 110 containing information relating to the transcripts of the project, an annotation table 112 containing information relating to the annotations created by particular users with respect to particular transcripts, an issue list table 114 with information about the issues associated with annotations, and other tables which are used to provide various functionality within the transcript management software. It is understood that the database schema diagram shown in FIGS. 16A-B is provided by way of example only, and that if a database implementation is utilized, its particular content and structure is a matter of choice depending upon the particular implementation.

Referring again to FIGS. 15A-B, global unique identifiers (GUIDs) (which are in one example 128 bits) are generated for each column of the master database. Immediately after replication, the off-line database has the same GUIDs as the master database. GUIDs are also generated for each column of the off-line database as the user changes the off-line project The GUIDS, in one example, are generated using the Microsoft Windows API.

At operation 5, the master database/off-line database are compared to determine any differences therebetween, preferably by comparing the GUIDs for each column of the databases. In one example, the JRO compares the unique global unique identifiers which have been generated for each column of each database, in order to determine whether there are differences between the databases and to identify what those differences are. In one example, the synchronization/comparison is performed for each column of each table in the database, and updates thereto are done to each column of each table.

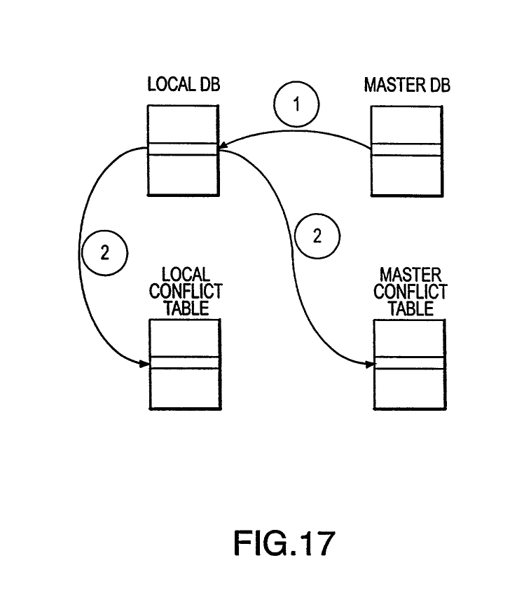

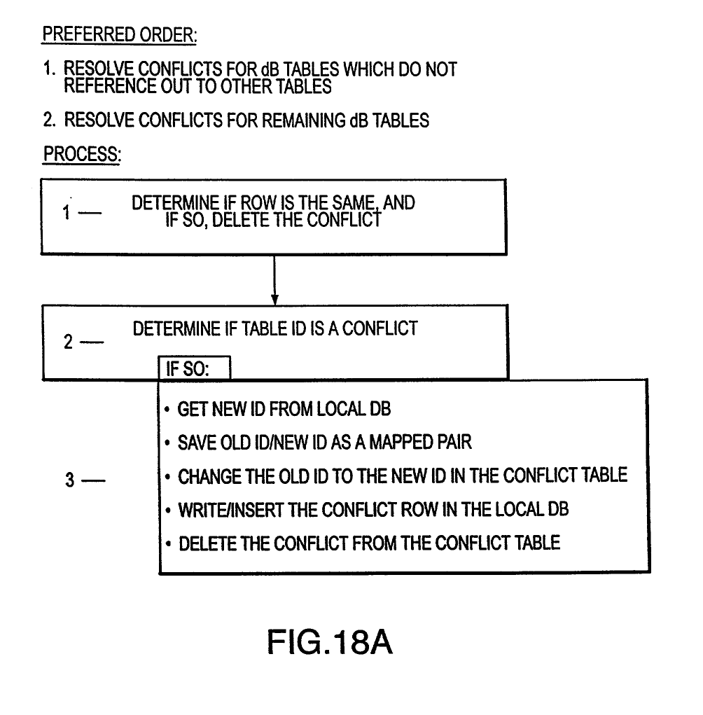

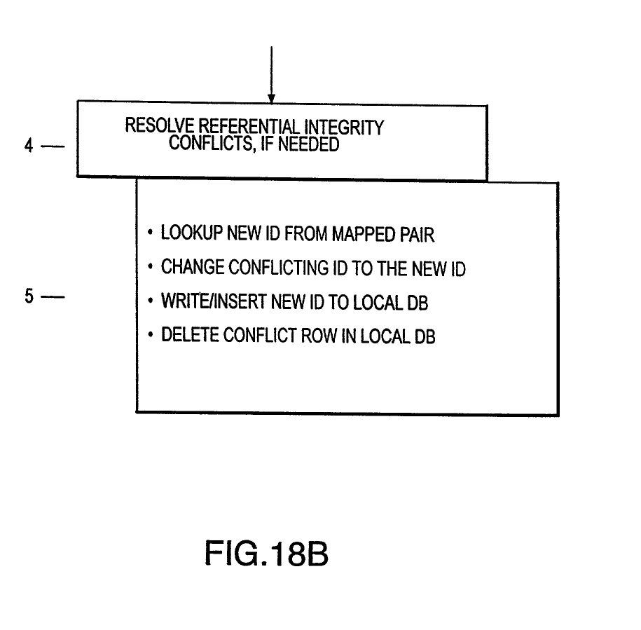

Assuming that there are differences between the databases, operation 6 writes to the off-line local database changes originating from the master database. If a conflict exists, then the local version of the column data is preferably written to a conflict table for handling later (see FIGS. 18A-B)(see also FIG. 17, step 2), and the master's version of the column of the table is written to the local database (which overwrites the local) (see FIG. 17, step 1). In one example, a conflict table is created in each database, one for each table of the database, if there are conflicts for that database table. For each table of the database that has a conflict identified, a conflicts table is created and maintained both locally and on the master database. Various scenarios of conflicts are described above. For example, a conflict exists when two different transcripts have the same identifier (created, for example, by two different users). In one example, a conflict exists only when a change is made to the off-line project database.

Operation 7 writes to the master database changes originating from the local off-line database. If there are any conflicts created by operation 7, the conflicts can be handled in a manner as described with reference to operation 6, above.

At operation 8, conflicts which were identified and written to the conflict tables are resolved, handled and repaired, preferably as further described with reference to FIGS. 18A-B. Once the conflicts are resolved, operation 9 writes to the master database any changes that were made to the local off-line database (for instance, as a result of operations 6-8), and the conflicts tables are deleted, in one example. Operation 9 ensures that the master database reflects the off-line database after the conflicts have been resolved. After operation 9, the end result is that both databases are identical. In one instance, operation 9 can be implemented by looping to operation 1.

FIGS. 18A-B illustrate the logical operations for resolving conflicts, in accordance with one embodiment of the present invention. In handling the conflicts, one primary objective is to maintain referential integrity. For example, a transcript cannot be removed from a project database without removing the annotations associated with the transcript, otherwise referential integrity is jeopardized. In order to resolve conflicts, the conflicts are preferably resolved in the following order. Conflicts for database tables which themselves do not depend on or reference other database tables are preferably resolved first. In other words, the conflicts in tables which do not reference other tables are resolved first, even if the tables are referenced by other tables. Secondly, the conflicts associated with the remainder of the database tables are then resolved.

Referring to FIGS. 18A-B, the conflict resolution process at operation 1 determines if the rows in the off-line/master databases flagged as in conflict are the same (for example, when a row is updated but remains equivalent). In particular, each conflict is examined first to determine if the row is the same. If the row is the same, then the conflict is preferably deleted in the local database.

At operation 2, a determination is made whether the table ID, which uniquely identifies the items within the databases, is in conflict. If so, then at operation 3, a new ID from the local database is obtained; the old ID and new ID are saved to memory preferably as a mapped pair so that other references to the old ID can be properly mapped to the new ID; the old ID is changed to the new ID in the conflict table; the conflict row is written/inserted into the local database; and finally the conflict is deleted from the conflict table of the local database.

At operation 4, any referential integrity conflicts are resolved. A referential integrity conflict is, for example, where something references something else which is in conflict. To handle such a conflict, operation 5 looks-up a new ID from the mapping pair created above; the conflicting ID is changed to the new ID; the new ID is written/inserted to the local database; and the conflict row is deleted in the local database.

Referring to the example database schema of FIGS. 16A-B, conflicts in these six tables are preferably resolved first: NextIds 116, UserRL 118, SearchGroupRL 120, IssueRL 122, ExhibitRL 124, and FolderRL 126. None of these tables have foreign key constraints referring to other tables, so their conflict resolution is simpler because their conflicts will be Unique ID conflicts only, and not Referential Integrity conflicts. However, each of these tables are referred to by other tables in the other tables' foreign key constraints, so when new IDs are generated in resolving conflicts in these five tables, a map of old ID to new ID is kept.

In one example for FIGS. 16A-B, NextIds 116 conflicts are resolved first, and the UserRL 118 conflicts are resolved, followed by SearchGroupRL 120. Because SearchGroupSettingsRL 128 refers to both UserRL 118 and SearchGroupRL 120, the conflict resolution function for SearchGroupRL 120, when finished, calls the conflict resolution function for SearchGroupSettingsRL 128. Next, IssueRL 122 conflicts are resolved. Again, because IssueSettingsRL 130 refers to both UserRL 118 and IssueRL 122, the conflict resolution function for IssueRL 122, when finished, calls the conflict resolution function for IssueSettingsRL 130. Next, ExhibitRL 124 and FolderRL 126 conflicts are resolved.

In one example for FIGS. 16A-B, conflict resolution for the remaining tables is more complex, because they all have foreign key constraints referring to other tables. Preferably, the next table to have its conflicts resolved is TranscriptsRL 110. As each transcript conflict is resolved, its reference to the FolderRL 126 table is changed if necessary, based on the map kept during FolderRL conflict resolution. Also, at this time, records which refer to the current record in TranscriptRL 110 are also changed in the following tables: AnnotationsRL 112, TranscriptTOCEntryRL 132, SearchGroupMemberRL 134, OfflineDocRL 136. When TranscriptRL ID values are changed, a map is kept of those changes. Next, AnnotationRL 112 conflicts are resolved, and a map of changed ID values is kept for that table. Next, ReportRL 138 conflicts are resolved, including referential integrity with TranscriptRL 110 and SearchGroupRL 120 (whose changed IDs were mapped at the time they were changed). Next, ExhibitListRL 140 conflicts are resolved, including referential integrity with ExhibitRL 124 and AnnotationRL 112 (whose changed IDs were mapped at the time they were changed). Next, IssueListRL 114 conflicts are resolved, including referential integrity with IssueRL 122, AnnotationRL 112, and ReportRL 138 (whose changed IDs were mapped at the time they were changed).

In case any conflicts still exist in SearchGroupMemberRL 134, TranscriptTOCEntryRL 132, and OfflineDocRL 136 that weren't resolved during TranscriptRL conflict resolution, those conflicts are resolved next, in one example. In case SearchGroupSettingsRL 128 and IssueSettingsRL 130 conflicts were not resolved during SearchGroupRL 120 and IssueRL 122 conflict resolution, those conflicts are resolved next, in one example. Finally, NextIds conflicts are again resolved; this table is saved for last because it is changed as conflicts are resolved in each of the other tables.

When all conflicts have been resolved the result is that the local projects have been corrected; and these corrected local projects should be written over to the master database. Preferably, a second call to the synchronization engine is made so that the local database changes are written to the master database (see operation 9 of FIGS. 15A-B).

With respect to the search index, preferably, a local copy of the master word index is provided for each user on the users local computer. In the event that the user selects a subset of transcripts from a project to be available off-line, then, in accordance with one embodiment of the present invention, a local search index is updated as transcripts are added or removed to or from the off-line project. Preferably as described above, each user's computer has a master word index, provided to enhance the speed of access to the words listed therein; an off-line word index, which allows multiple users to use and alter the master word index without contention; and an off-line project which removes the inter-dependency between users who change the transcripts between the projects.

The word index is preferably built on the opening of the transcript management software, but such a feature can be provided under user control. In one example, the word index is built at the last step of the synchronization process, and the word index is based on the transcripts that are stored locally so as to provide an off-line word index.

### Automatic Off-Line/On-Line Project Status Determination

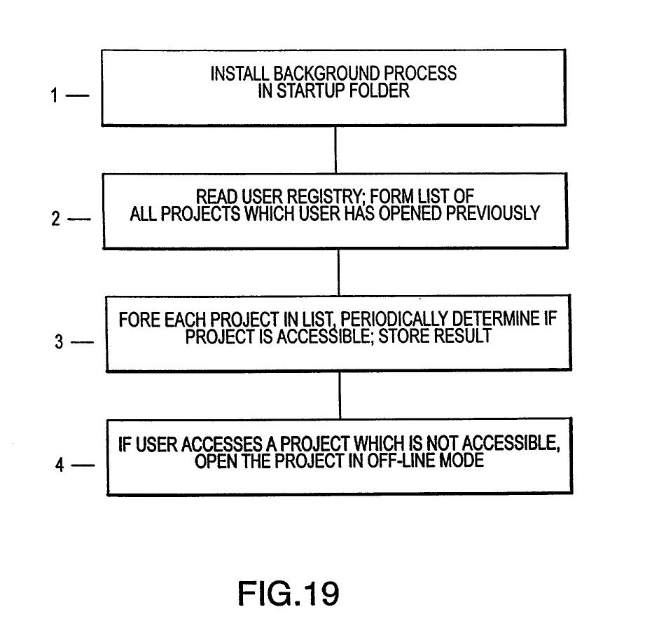

Now referring to FIG. 19 and the automatic detection of whether a project is available on-line or off-line, most network protocols typically retry to establish a network connection if the network is not accessible, and such an operation can take a number of seconds before the software is completed with its retry attempts. In one example, Microsoft Windows may take approximately 45 seconds to determine if a network connection is not available. Accordingly, one embodiment of the present invention provides a background process on each user's computer which monitors the network availability for each project used by the user. A list of all network projects is maintained, and the background process determines, periodically, if each project is accessible over the network.

In one example, the background process starts during software initialization of Microsoft Windows™ (through the Windows™ start-up menu) so that by the time that Windows has completed its initialization, the transcript management software program already knows whether a project or set of projects are available on-line. In this manner, when a user opens the transcript management software and access a project which should be available on-line, but is not available on-line because a network connection is not available, the user is immediately informed of this fact and the project is opened in off-line operations. Therefore, the software automatically opens the off-line project when a network connection does not exist.

FIG. 19 illustrates the logical operation for determining the availability of a project on-line. At operation 1, the background process is preferably installed into the users start-up folder, so that the process will run in the background when the user logs in or initiates the users machine. At operation 2, the background process reads the user registry, and makes a list of all projects which the user has previously opened before. This step assumes that the transcript management software writes the project location in the user registry, as described above.

At operation 3, for each project, the background process periodically tests if it can access each project in the list, preferably every 30 seconds. In one example, this is performed by calling the C “access” function which tests for the existence of a file. For example, if the project is available on the network, but there is no network connection, the return from the access function will indicate a failure. At operation 3, the results for the access function for each project are preferably stored in memory. At operation 4, when the transcript management software opens a project, it preferably calls the background process and queries whether a project is available. If the project is not available, the transcript management software opens the off-line project immediately, thereby saving the user potentially much time (in one example, 45 seconds) which would have been needed to determine that the project was not available on-line.

The following code block is an example of a thread function which operates as a background process to periodically check file access of each project file listed in the user's registry settings:

void _cdecl ThreadFunc (void *arg)
{

CExeModule *pS = (CExeModule *)arg;
ServerMap localMap;
ServerMap::iterator iter;
BOOL bForce;
while (pS−>m_bThreadActive)
{
// block the access functions from mucking with the map
WaitForSingleObject (hMutex, INFINITE);
// make a local copy of the map
localMap.clear( );
for(iter = pS−>GetMap( ).begin( ); iter != pS−>GetMap( ).end( );

iter++)

```
{
localMap.insert (ServerMap::value type(iter−>first, iter−>second));
}
bForce = pS−>m_bForce;
// we're done with the map
ReleaseMutex (hMutex);
for(iter = localMap.begin( ); iter != localMap.end( ); iter++)
{
if(bForce)
{
iter−>second = FALSE;
}
else
{
LPCTSTR pszFile = iter−>first.c_str( );
// see if the project file exists - if it does, mark available
as
// TRUE
if(!_access(pszFile,0))
{
iter−>second = TRUE;
}
else
{
iter−>second = FALSE;
  }
  }
}
// now put the map back
// block the access functions from mucking with the map
WaitForSingleObject (hMutex, INFINITE);
pS−>GetMap( ).clear( );
for(iter = localMap.begin( ); iter != localMap.end( ); iter++)
{
pS−>GetMap( ).insert(ServerMap::value_type(iter−>first, iter−>
second));
// we're done with the map
ReleaseMutex (hMutex);
// thru the list, now wait a while before trying again
Sleep(30000); // every 30 seconds
}
_endthread( );
```

}
The following code represents an example of a COM
interface that a transcript management program can use to query the
above program for availability of a project:
extern CExeModule _Module;
extern HANDLE hMutex;
STDMETHODIMP CIsProjectAvailable::IsProjectAvailable(BSTR
bzProject)
{

_bstr_t bStr = bzProject;
// wait till we're allowed access to the map
WaitForSingleObject (hMutex, INFINITE);
ServerMap::iterator iter =
_Module.GetMap( ).find(std::string((char *)bStr));
if(iter != _Module.GetMap( ).end( ))
{
BOOL bRet = iter−>second;
ReleaseMutex (hMutex);
if (bRet)
{
return S_OK; // YES, project is available
}
else
{
return S_FALSE; // NO, project not available
}
}
else
{
ReleaseMutex(hMutex);
return S_FALSE;
}

}

It is understood that the above computer source codes are provided by way of example only, and that the manner in which the embodiments of the present invention are coded in a particular implementation will vary.

### XML Transcript Data and Video

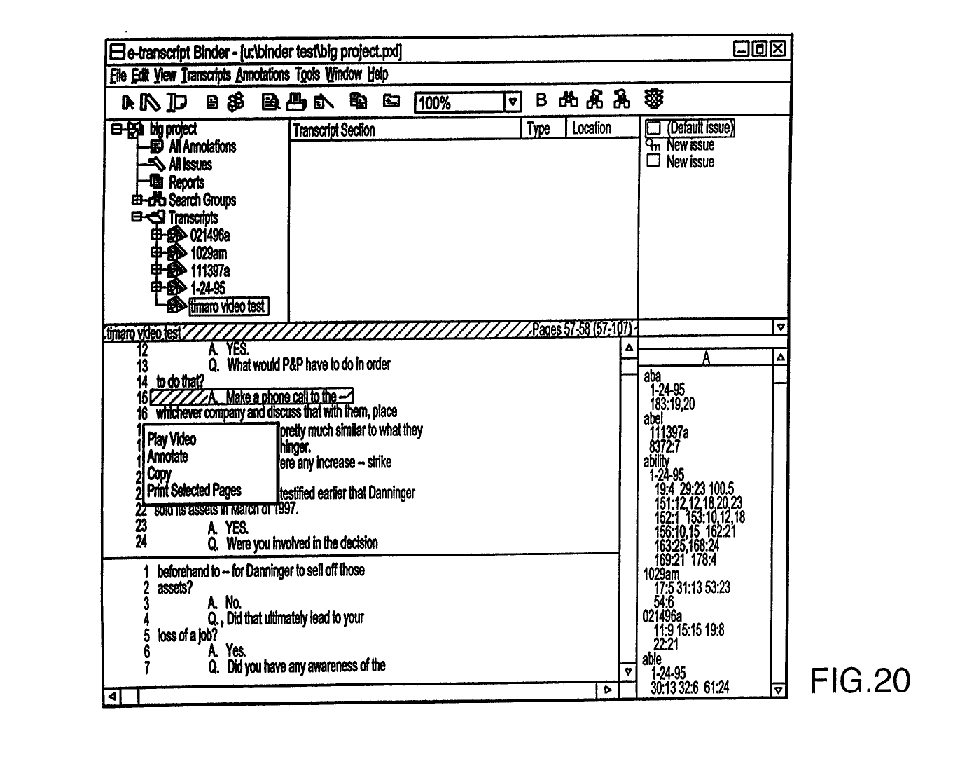

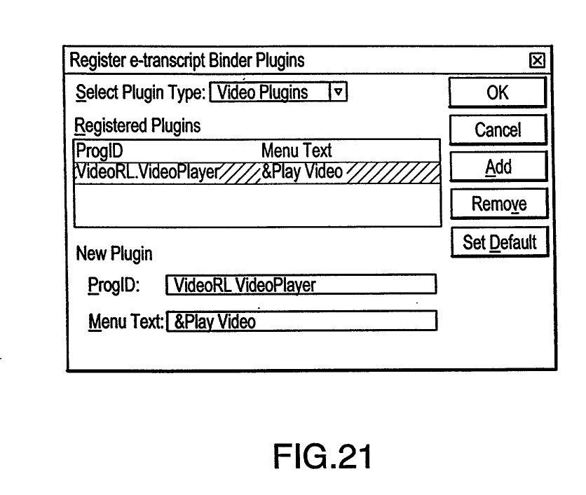

FIGS. 20-21 illustrate the ability of a user to select/launch the playing of segments of video associated with particular sections of an electronic transcript, in accordance with one embodiment of the present invention. Synchronized video support is provided using an XML data format, wherein within the XML data format, data regarding the transcript, video tags associated with the transcript, and annotations and issues are encoded within the XML format. The video tags of the XML format represent a pointer to the video file and a mapping to the page/line position within the transcripts, in accordance with one embodiment of the present invention. When a user imports a transcript into the transcript management software, preferably, the video tag is recognized, and the transcript (XML document) is placed in a video folder. The user can then play the video for the transcript, which launches a video player (in one instance, the e-TRANSCRIPT BINDER™ video player from realLegal.com), and jumps to the correct offset within the video based on where the user has highlighted the corresponding transcript. Further, the transcript management software preferably highlights the text as the video is being played. Accordingly, video information and transcript information are combined in a single XML file using video tags. It is understood that the same principles can be used for audio information, or flash information.

The following is a partial XML file showing video tags used for synchronized video viewing, in accordance with one embodiment of the present invention. The VideoSource tag gives the filename of the video file; the MediaLabel tag gives the name of the CD-ROM (or other resource) containing that file; the Offsets tag gives the starting and ending line of the transcript corresponding to the video file; the Offset tag gives an offset (in ms) into the video file corresponding to each line in the transcript. The actual transcript data in the XML file are not shown in this example XML file.

<?xml version=“1.0” standalone=“no”?>
<!DOCTYPE BinderTranscriptInfo SYSTEM “bndr2001_02_12.dtd”>
<BinderTranscriptInfo>
<StructureEntries>
</StructureEntries>
<Issues></Issues>
<Annotations>/Annotations>
<Video>

<VideoSources>
<VideoSource ID=“vs000”Type=“file”Format=“Mpeg2”

Source=“REEPMOV2a.mpg”>
<MediaLabel>Timaro Technologies CD-ROM</MediaLabel>
<Offsets StartID=“Off:Line000:0”EndID=“Off:Line522:end”>
<Offset ID=“Off:Line000:0”Off=“0”/>
<Offset ID=“Off:Line001:0”Off=“0”/>
<Offset ID=“Off:Line002:0”Off=“3000”/>
<Offset ID=“Off:Line003:0”Off=“7000”/>
<Offset ID=“Off:Line004:0”Off=“9000”/>
<Offset ID=“Off:Line005:0”Off=“11000”/>
<Offset ID=“Off:Line521:0”Off=“680000”/>
<Offset ID=“Off:Line522:0”Off=“680000”/>
<Offset ID=“Off:Line522:end”Off=“680000”/>

</Offsets>
</VideoSource>
</VideoSources>
</Video>

The following is the dtd file which defines the tags used
in the above XML document:
<!−− For an XML document to be “valid” we must define all the standard
entities −−>
<!ENTITY lt “&#38;#60;”>
<!ENTITY gt “&#40;”>
<!ENTITY amp “&#38;#38;”>
<!ENTITY apos “&#39;”>
<!ENTITY quot “&#34;”>
<!−− Non-breaking space for explicitly preserving whitespace −−>
<!ENTITY nbsp “&#32;”>
<!−−
(element) Element count must be 1
(element)? Element count must be 0 or 1
(element)+ Element count must be 1 to N
(element)* Element count must be 0 to N
−−>
<!ELEMENT BinderTranscriptInfo (StructureEntries, Issues, Annotations,
(Video)?, Transcript) >
<!−− ++++++++StructureEntries ++++++++ −−>
<!ELEMENT StructureEntries (StructureEntry)* >
<!ELEMENT StructureEntry (TranscriptRange, EntryTitle, EntryText,
(StructureEntry) *) >
<!ATTLIST StructureEntry Type NMTOKEN #REQUIRED >
<!ELEMENT EntryTitle (#PCDATA) >
<!ELEMENT EntryText (#PCDATA) >
<!−− ++++++++TranscriptRange ++++++++ −−>
<!ELEMENT TranscriptRange (StartPoint, Endpoint) >
<!ELEMENT StartPoint EMPTY >
<!ATTLIST StartPoint LineID NMTOKEN #REQUIRED

Pos NMTOKEN #REQUIRED >

<!ELEMENT EndPoint EMPTY >
<!ATTLIST EndPoint LineID NMTOKEN #REQUIRED

Pos NMTOKEN #REQUIRED >

<!−− ++++++++Issues ++++++++ −−>
<!ELEMENT Issues (Issue)* >
<!ELEMENT Issue (#PCDATA) >
<!ATTLIST Issue ID ID #REQUIRED
Color NMTOKEN #REQUIRED
Begin CDATA #IMPLIED >
<!−− ++++++++Annotations ++++++++ −−>
<!ELEMENT Annotations (Annotation)* >
<!ELEMENT Annotation (DateTime,
TranscriptRange, IssueList, Comment,
Attachment) >
<!ATTLIST Annotation ID ID #REQUIRED >
<!ELEMENT DateTime EMPTY >
<!ATTLIST DateTime Year NMTOKEN #REQUIRED

Month NMTOKEN #REQUIRED
Day NMTOKEN #REQUIRED
Hour NMTOKEN #REQUIRED
Minute NMTOKEN #REQUIRED
Second NMTOKEN #REQUIRED >

<!ELEMENT IssueList (IssueID)+>
<!ELEMENT IssueID EMPTY >
<!ATTLIST IssueID IDREF IDREF #REQUIRED >
<!ELEMENT Comment (#PCDATA) >
<!ELEMENT Attachment (Locator) >
<!ELEMENT Locator (#PCDATA) >
<!−− ++++++++Video ++++++++ −−>
<!ELEMENT Video (VideoSources) >
<!ELEMENT VideoSources (VideoSource)* >
<!ELEMENT VideoSource (MediaLabel, Offsets) >
<!ATTLIST VideoSource ID ID #REQUIRED

Type (file | stream) “file”
Format (Mpeg2 | Mpeg3) “Mpeg2”
Source NMTOKEN #REQUIRED >

<!ELEMENT MediaLabel (#PCDATA) >
<!ELEMENT Offsets (Offset)* >
<!ELEMENT Offset EMPTY>
<!ATTLIST Offset ID ID #REQUIRED

Off NMTOKEN #REQUIRED >

<!−− ++++++++Transcripts ++++++++ −−>
<!ELEMENT Transcript (Head, Body) >
<!−− Head element −−>
<!ELEMENT Head (Title, Date, (Flags, Reporter, Company, Witness,
Examiner, DeposedBy, GUID)?) >
<!−− The head elements −−>
<!ELEMENT Title (#PCDATA) >
<!ELEMENT Date (#PCDATA) >
<!ELEMENT Flags EMPTY>
<!ATTLIST Flags IsDraft (Yes | No) “No”

IsSealed (Yes | No) “No”>

<!ELEMENT Reporter (#PCDATA) >
<!ELEMENT Company (#PCDATA) >
<!ELEMENT Witness (#PCDATA) >
<!ELEMENT Examiner (#PCDATA) >
<!ELEMENT DeposedBy (#PCDATA) >
<!ELEMENT GUID (#PCDATA) >
<!−− Body of transcript consists of the layout information, and the
text itself −−>
<!ELEMENT Body (Layout, Text) >
<!−− Layout section of transcript −−>
<!ELEMENT Layout (Page)+ >
<!ELEMENT Page (Line)* >
<!ATTLIST Page ID ID #REQUIRED

Number NMTOKEN #REQUIRED
Visible (Yes | No) “Yes”>

<!ELEMENT Line (SpanRef)+ >
<!ATTLIST Line ID ID #REQUIRED

Number NMTOKEN 4 IMPLIED
Indent NMTOKEN 4 IMPLIED >

<!ELEMENT SpanRef EMPTY >
<!ATTLIST SpanRef IDREF IDREF #REQUIRED >
<!−− Text section of transcript −−>
<!ELEMENT Text (Speech | Span)+ >
<!ELEMENT Speech (Span)+ >
<!ATTLIST Speech Type NMTOKEN #REQUIRED >
<!ELEMENT Span (#PCDATA) >
<!ATTLIST Span ID ID #REQUIRED

Begin CDATA #IMPLIED >

It is understood that the above computer source code is provided by way of example only, and that the manner in which the embodiments of the present invention are coded in a particular implementation will vary.

The embodiments of the invention described herein are implemented as logical operations in a computing system. The logical operations of the present invention are implemented (1) as a sequence of computing implemented steps running on the computing system and (2) as interconnected machine modules within the computing system. The implementation is a matter of choice dependent on the performance requirements of the computing system implementing the invention. Accordingly, the logical operations making up the embodiments of the invention described herein are referred to variously as operations, steps, or modules.

The above described computer implemented operations or steps in another implementation of the present invention are provided as an article of manufacturer, i.e., a computer storage medium containing a computer program of instructions for performing the above described operations or steps.

While the methods disclosed herein have been described and shown with reference to particular operations or steps performed in a particular order, it will be understood that these operations or steps may be combined, sub-divided, or re-ordered to form equivalent methods without departing from the teachings of the present invention. Accordingly, the order and grouping of the operations or steps is not generally intended to be a limitation of the present invention.

While the invention has been particularly shown and described with reference to various embodiments thereof, it will be understood by those skilled in the art that various other changes in the form and details may be made without departing from the spirit and scope of the invention.

We claim:

1. A method, comprising:
providing a database containing one or more electronic transcript files and having one or more sets of annotations associated with the one or more electronic transcript files, said database being accessible over a network;
creating an off-line database in a user device, said off-line database containing a copy of at least one of said electronic transcript files and a copy of at least one set of said annotations;
in the user device while said user device is not connected to said network, providing for manipulation of the copy of at least one set of said annotations to form an off-line version of said annotations;
detecting when said user device is connected to said network; and
responsive to said detecting step, determining if said off-line version of said annotations contains a change from said one or more sets of annotations in said database, and if so, writing said change to said database.

2. The method of claim 1, further comprising:
responsive to said detecting step, determining if said one or more sets of annotations in said database contain a change from said off-line version of said annotations, and if so, writing said change to said off-line database.
